(19) United States
(12) Patent Application Publication
(10) Pub. No.: US 2010/0237658 A1
(43) Pub. Date: Sep. 23, 2010

(54) VEHICLE FRAME

(75) Inventors: MARIUS ALLAIRE, Quebec (CA); Étienne Loiselle, Quebec (CA); Laurier Tremblay, Quebec (CA)

Correspondence Address: Joseph Bain;Novak Druce & Quigg LLP, 525 Okeechobee Blvd, Suite 1500, West Palm Beach, FL, 33401, US

(73) Assignee: L'EQUIPE FABCONCEPT INC., Quebec (CA)

(21) Appl. No.: 12/708,110

(22) Filed: Feb. 18, 2010

Related U.S. Application Data
(60) Provisional application No. 61/202,323, filed on Feb. 18, 2009.

(51) Int. Cl. B62D 25/00; F28D 15/00

(52) U.S. Cl. 296/203.01; 165/104.19

(57) ABSTRACT

A vehicle frame comprises a structural portion of sheet material provided with a series of bents formed therein to increase the stiffness of the structural portion, portions of the sheet material being alternatively located on each side of a neutral flexion axis of the structural portion. A method and a kit providing same are also provided.

### CROSS REFERENCE TO RELATED APPLICATIONS

This Application claims priority on U.S. Provisional Application No. 61/202,323, filed on Feb. 18, 2009, which is herein incorporated by reference.

### FIELD OF THE INVENTION

The present application generally relates to vehicle frames having shaped reinforcements therein.

### BACKGROUND OF THE INVENTION

The frame of a vehicle provides longitudinal, transversal and torsional rigidity to the vehicle. The maneuverability of the vehicle is affected by the stiffness of the frame.

More material can be added to the frame to improve rigidity. Additional structural members could also be added to reinforce specific areas of the frame. The weight of the frame is therefore increased by the additional frame material and additional members. A need, therefore, exists for an improved frame providing additional stiffness to the vehicle while limiting its weight.

Heat exchangers on off-road vehicles are subject breakage by the hostile environment in which the vehicles evolve. It is desirable to have a means to exchange heat on an off-road vehicle that is less vulnerable to the environment.

A need for an improved frame and an improved heat exchanger over the existing art has been felt.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description of exemplary embodiments, which is presented later.

A frame of the present invention (including a kit therefor) may, by way of example, be exploited in relation to an all-terrain vehicle. However, the frame and the heat exchanger system of the present specification may be used in relation to other vehicles adapted to serve in contexts that differ from the embodiments illustrated hereinafter.

It is to be understood herein that the term all-terrain vehicle generally refers to an off-road vehicle although the vehicle could alternatively be used on the road. It is further understood that the term endless belt generally refers to a caterpillar-type drive adapted to impart motive power from the vehicle to the ground by a means that provides a wider ground footprint than a wheel. An endless belt, or a caterpillar, can be made of articulated steel parts, rubber, composite materials (woven material and rubber) or other material suitable to this end.

Therefore, one other object of the present invention improves at least some of the deficiencies associated with a frame intended to be adapted to an all-terrain vehicle.

An object of the present invention provides a frame that is shaped and designed to increase the rigidity of the vehicle assembly while limiting the weight of the vehicle.

Another object of the present invention provides a frame that is provided with a series of shapes formed therein to improve its rigidity.

One object of the present invention provides a frame adapted to be used as a heat exchanger to cool heat generating elements of the vehicle.

An additional object of the present invention provides a frame provided with rigidifying shapes thereon adapted to receive fluid circulation means adapted to transfer heat from the fluid to the environment through the frame.

One additional object of the present invention provides a frame defining a shaped portion adapted to geometrically mate with a fluid carrying means to draw thermal energy from the fluid and further adapted to dissipate thermal energy to the environment.

An additional object of the present invention provides double-purpose frame shapes adapted to increase the stiffness of a frame and to also serve as a heat exchanger.

Another additional object of the present invention provides a series of reinforcement shapes disposed on the bottom portion of a frame of a vehicle to reinforce an area of the frame prone to enter in contact with foreign objects on the ground.

An additional object of the present invention provides a series of reinforcement shapes disposed on portions of a frame that are more likely to be splashed with water when the vehicle is used, wet portions of the frame having increased heat exchanging capacity due, at least in part, by change of phase of liquid water to vapor.

An aspect of the present invention provides a series of shapes formed on a flat lower portion of a frame.

Another aspect of the present invention provides a series of cooperating semi-circular shapes disposed on the floor of a vehicle.

One aspect of the present invention provides a series of shaped reinforcements disposed on the frame of a vehicle between two ground contacting members.

One other aspect of the present invention provides a series of shaped reinforcements formed in the frame of a vehicle above ground contacting members.

Another aspect of the present invention provides a cavity disposed on the frame of a vehicle, the cavity being adapted to receive heat exchanger elements therein and being bordered, at least in part, by a wall portion giving on the exterior of the vehicle.

One another aspect of the present invention provides a combined frame portion adapted to be structural and be used as a thermal heat exchanger.

Therefore, in accordance with the present invention, there is provided a vehicle frame comprising a structural portion of sheet material provided with a series of bents formed therein to increase the stiffness of the structural portion.

Also in accordance with the present invention, there is provided a vehicle frame comprising a structural portion of sheet material provided with a series of bents formed therein to increase the stiffness of the structural portion, wherein the structural portion is further adapted to be a heat exchanger by communicating thermal energy between a heat carrying means to the environment.

Further in accordance with the present invention, there is provided a method of exchanging heat from a vehicle to the environment, the method comprising:

providing a structural portion of sheet material having a series of bents formed therein to increase the stiffness of the structural portion;

providing a heat carrying means adapted to channel a heat-charged fluid from a heat generating element of the vehicle to the structural portion of sheet material; and

transmitting heat from the heat carrying means to the environment via the structural portion.

Other objects, aspects, advantages and features of the present invention will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIG. 1 is a front-right isometric view of an all-terrain vehicle;

FIG. 2 is a right side elevation view of the all-terrain vehicle of FIG. 1;

FIG. 3 is a front elevation view of the all-terrain vehicle of FIG. 1, but with the doors thereof in an open position;

FIG. 4 is a front-right isometric view of a frame of the all-terrain vehicle of FIG. 1;

FIG. 5 is a front-right isometric view, seen from a lower angle, of the frame of the all-terrain vehicle of FIG. 1;

FIG. 6 is a top plan view of the frame of the all-terrain vehicle of FIG. 1;

FIG. 7 is a right elevation section view of the frame of FIG. 6;

FIG. 8 is a rear elevation section view of the frame of FIG. 6; and

FIG. 9 is a rear-right isometric view of a portion of the frame of FIG. 7;

FIG. 10 is a schematic hydraulic circuit illustrating an embodiment of the present invention; and

FIG. 11 is a schematic sectional view of bents in a sheet material about a neutral flexion axis.

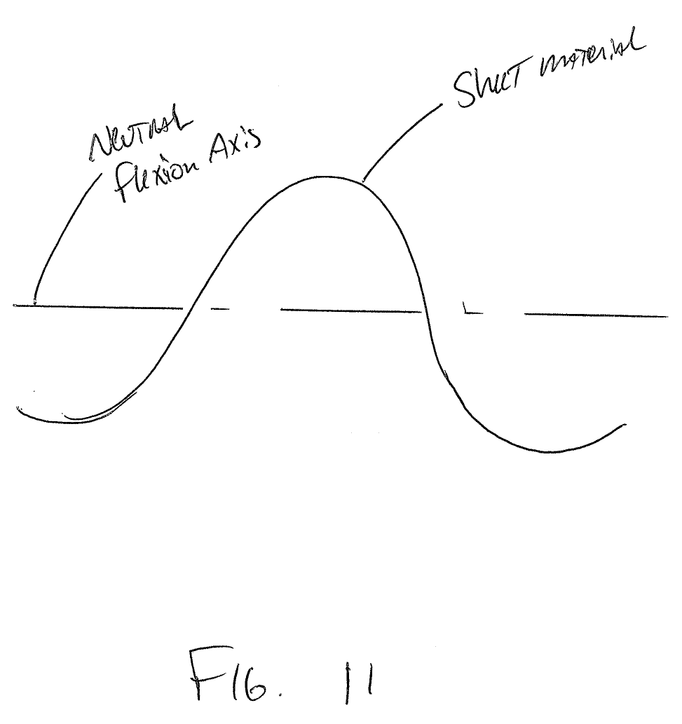

### DESCRIPTION OF ILLUSTRATIVE EMBODIMENT(S) OF THE INVENTION

The present invention will now be described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details.

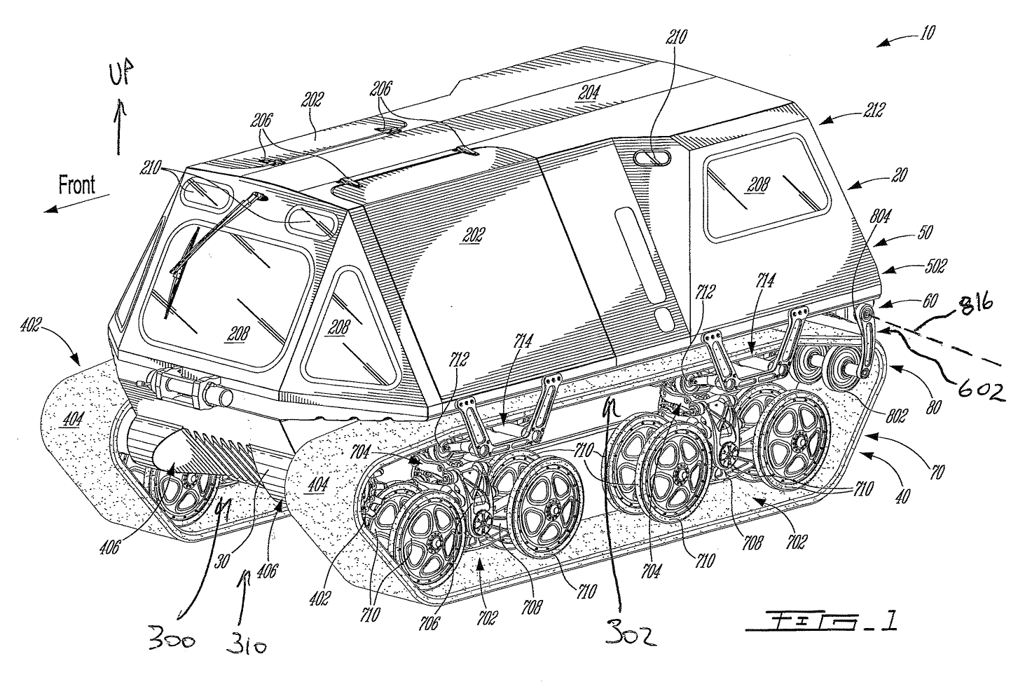

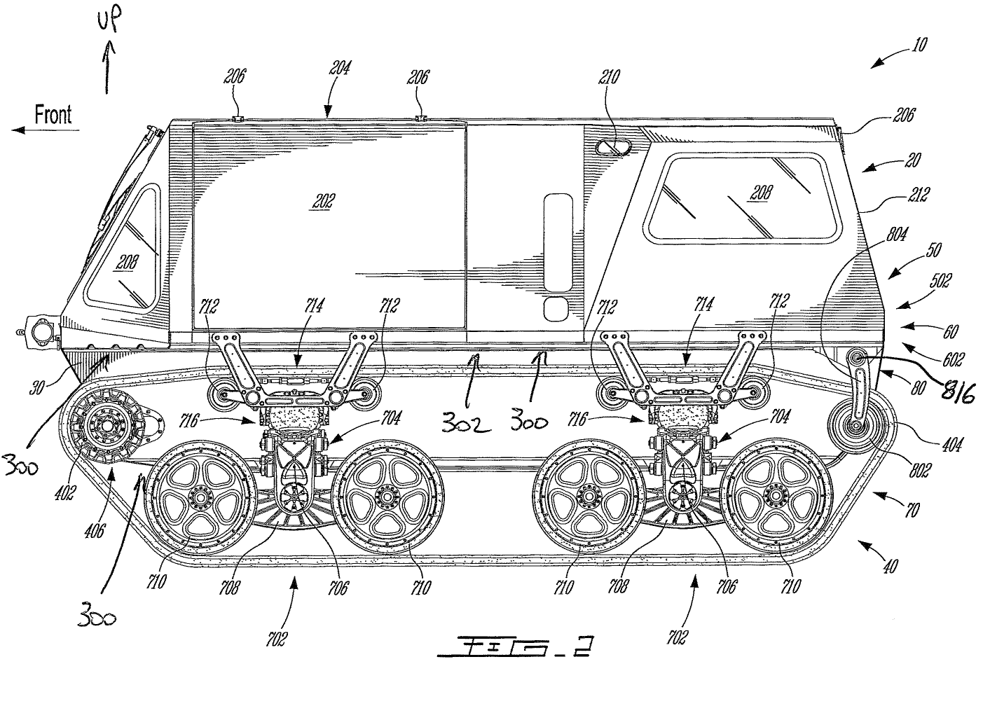

Thus, an embodiment of the invention is shown on FIGS. 1 to 3 embodied on an all-terrain vehicle 10. The all-terrain vehicle 10 is constituted, inter alia, of a passenger compartment 20, a frame 30, a drive system 40, a power pack 50, a hydraulic system 60, a suspension system 70 and a tensioner system 80. The passenger compartment 20 is provided with doors 202 pivotally secured on each side of a roof portion 204 via hinges 206, windows 208 disposed on the periphery of the vehicle 10, a back door 212 and a plurality of lights 210.

Manufacturing of the passenger compartment 20 of the illustrated embodiment is generally made in aluminum material for reasons of strength and weight. Other materials, like steel, plastic or composite materials, could be used within the scope of the present invention.

The passenger compartment 20 is mounted to the frame 30 thus forming a monocoque construction that enhances the rigidity and the strength of the overall vehicle assembly. Most parts of the vehicle assembly can be fastened, glued, welded, riveted or secured by other suitable means known in the art of vehicle manufacturing.

The power pack 50 is housed in and secured to the frame 30. The power pack 50 is preferably located low in the frame 30 to keep the center of gravity of the vehicle 10 as low as possible. Preferably, the power pack 50 is transversally centered in the vehicle 10 for reasons of lateral weight distribution. The longitudinal position of the power pack 50 can vary in accordance with the desired mass distribution and volume allocation. In this respect, the power pack 50 can be disposed in the center of the vehicle 10 to advantage mass distribution. Alternatively, the power pack 50 can be positioned toward the rear of the frame 30 to allow maximum room therein for passengers.

An internal combustion engine 502, e.g. a diesel or gas engine, powers a hydraulic system 60 via a rotating or reciprocating hydraulic pump 602. The internal combustion engine 502 could alternatively power more than one hydraulic system 60 and/or hydraulic pump 602. A plurality of hydraulic pumps 602 and/or hydraulic system 60 might be desirable for reasons of reliability if the vehicle 10 is expected to be used in extreme conditions by offering redundant systems. More than one hydraulic pump 602 also allows driving independently each endless belt 404. The pressurized hydraulic system 60 powers hydraulic motors 406 that, in turn, mechanically power the drive system 40 with drive sprockets 402. Intermediate planetary gearboxes (not shown) reduce the ratio between each hydraulic motor 406 and its associated sprocket 402. Sprockets 402 of the drive system 40 propel the vehicle 10 by engaging and turning the endless belts 404. Two hydraulic motors 406 are installed in the vehicle 10, each moving one of the two endless belts 404. The vehicle 10 is steered by a difference in rotation of the two hydraulic motors 406.

Still referring to FIGS. 1 to 3, the suspension system 70 comprises a plurality of suspension units 702. Each suspension unit 702 uses a double wishbone configuration 704 coupled on a proximal side to the frame 30 of the vehicle 10 and, on a distal side, to a hub 706. The hub 706 pivotally accommodates a tandem 708 to which are rotatably secured suspension wheels 710. Support wheels 712 are provided on an endless belt upper support 714 to maintain the upper side of the endless belt 404 on its way toward the front of the vehicle 10.

Tension in each endless belt 404 is independently managed by the tensioner system 80. Endless belt contacting wheels 802 are adapted to move along the radius generated by tension lever 804 about pivot axis 816 to extend or retract the circumference of its associated endless belt 404. The tensioner system 80 is adapted to provide proper tension in the endless belt 404 by dynamically adapting to operating conditions of the vehicle 10.

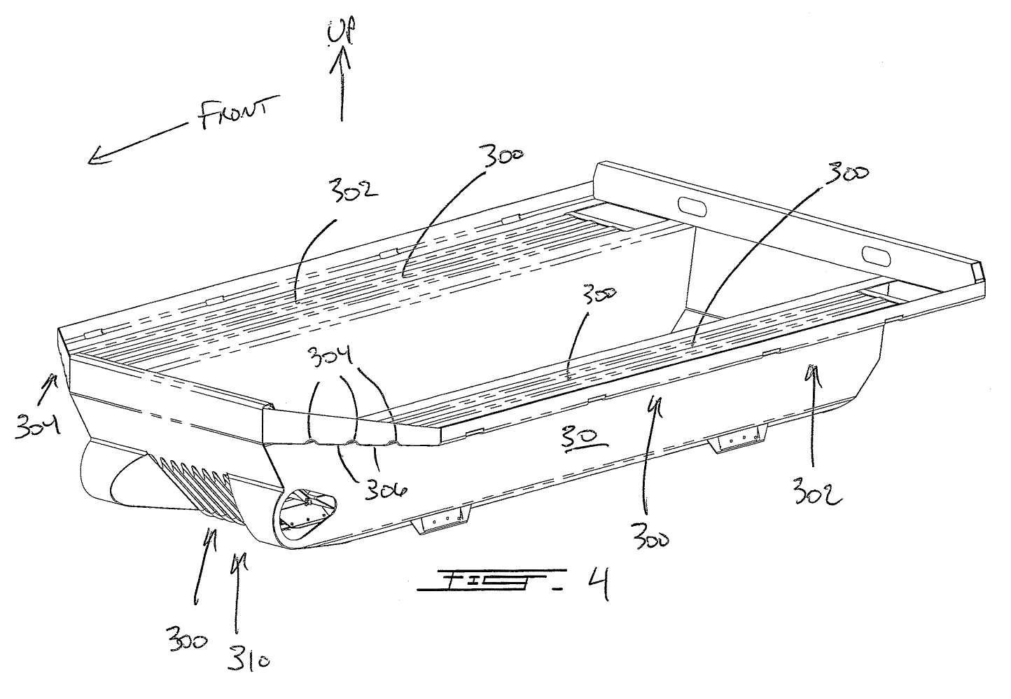

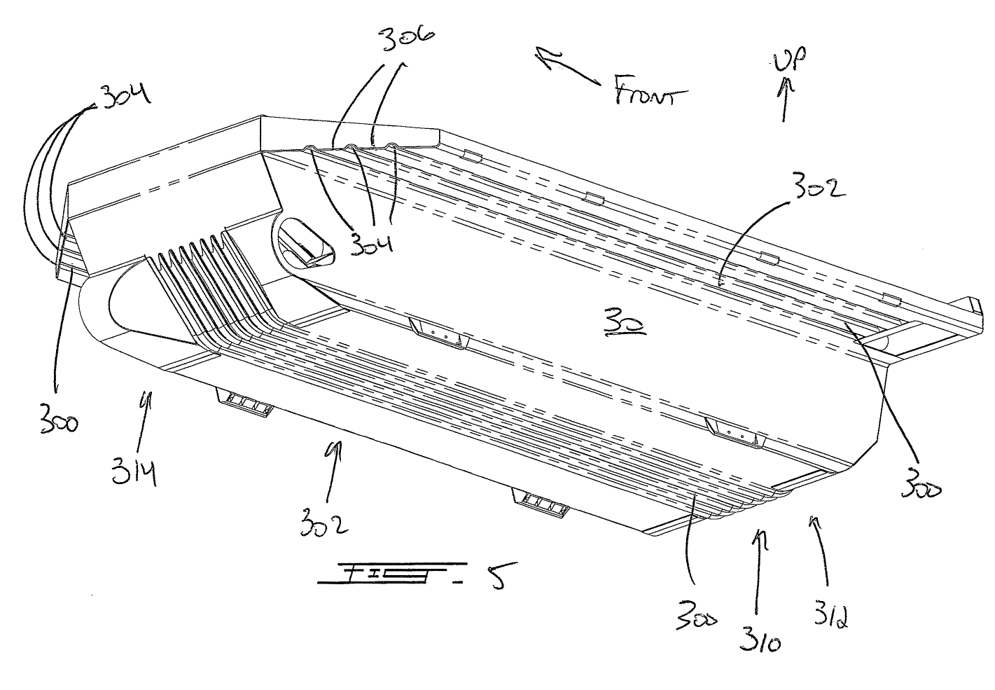

As better seen on FIGS. 4 through 9, it can be appreciated that the frame 30 provides a plurality of shaped portions 300 adapted to increase the stiffness of specific locations of the frame 30. Each shaped portion 300 comprises a series of ridges, or bents, in the material that are adapted to increase the stiffness of the shaped portion 300. The increase in stiffness is provided by positioning material on each side of a flexion axis thus increasing the moment of inertia without adding more material to the subject structure. The shaped portions 300 are disposed on, but not limited to, planar surfaces of the frame 30 that could have a tendency to bend under load. Bents can form semi-circular patterns 304 as illustrated in the figures herein and are preferably formed in the material prior to assembly of the shaped portion 300 to the vehicle 10. A punch and die process can be used to shape the material into the desired form.

A shaped portion 300, 302 is disposed on the frame 30 in a region located above each endless belt 404. Each shaped portion 300 is composed of a series of parallel semi-circular longitudinal pattern 304 punched in the sheet material of the frame 30. Each semi-circular longitudinal pattern 304 is separated from an adjacent semi-circular longitudinal pattern 304 by a planar portion 306. The semi-circular longitudinal pattern 304 illustrated in the present embodiment could have a different shape without departing from the scope of the present invention. Alternative shapes provided in the sheet material and adapted to increase the rigidity and/or the stiffness of the frame 30 could potentially replace the semi-circular longitudinal pattern 304.

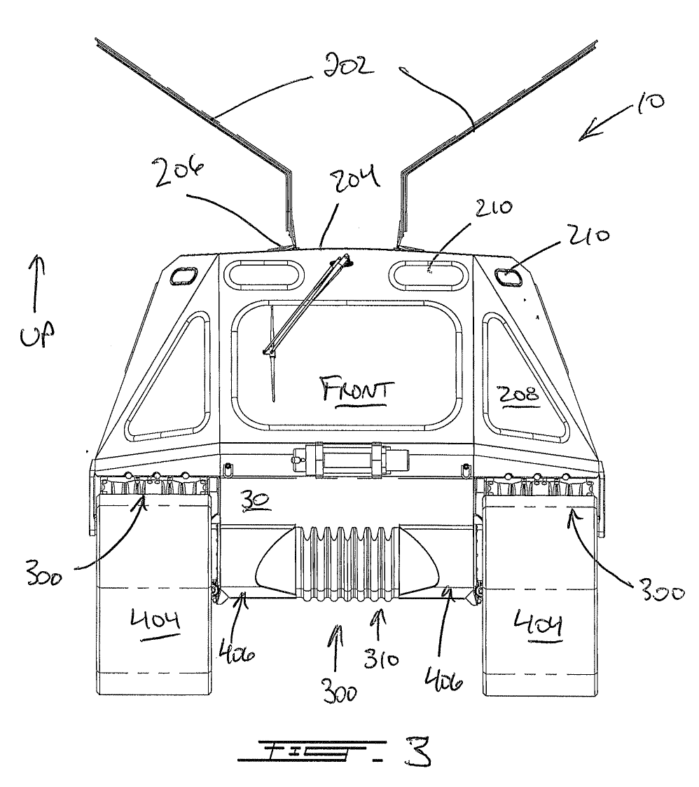

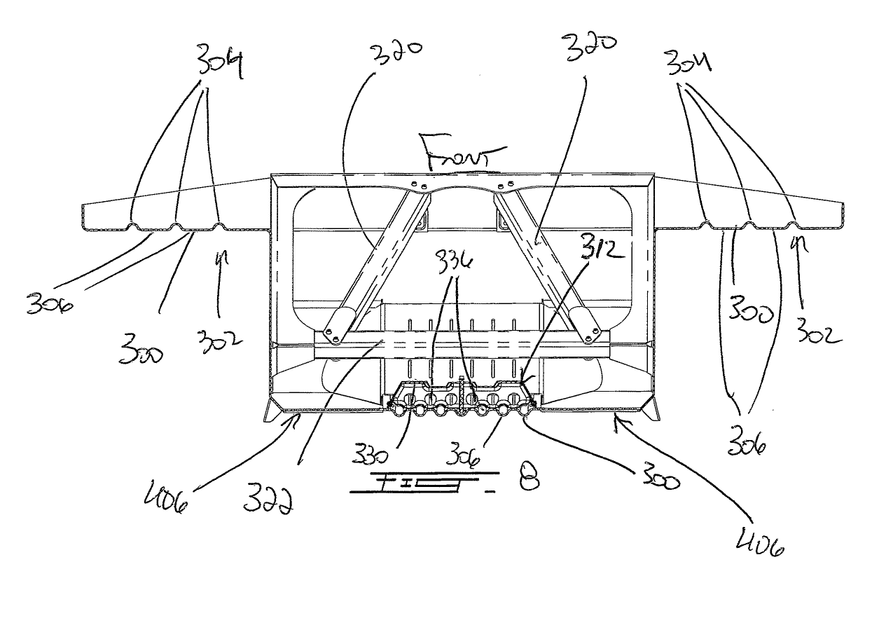

A shaped portion 300, 310 is located between the endless belts 404. The lower portion of the frame 30 is more subjected to be hit by foreign objects and requires a more robust structure. The shaped portion 310 of the frame is therefore provided with a more compact series of semi-circular longitudinal patterns 304 leaving, as best seen on FIGS. 3 and 8, no flat surface of material therebetween. The shaped portion 310 follows the contour of the shape of the frame 30 and extends on a rear portion 312 and a front portion 314 of the frame 30 to further protect the frame 30.

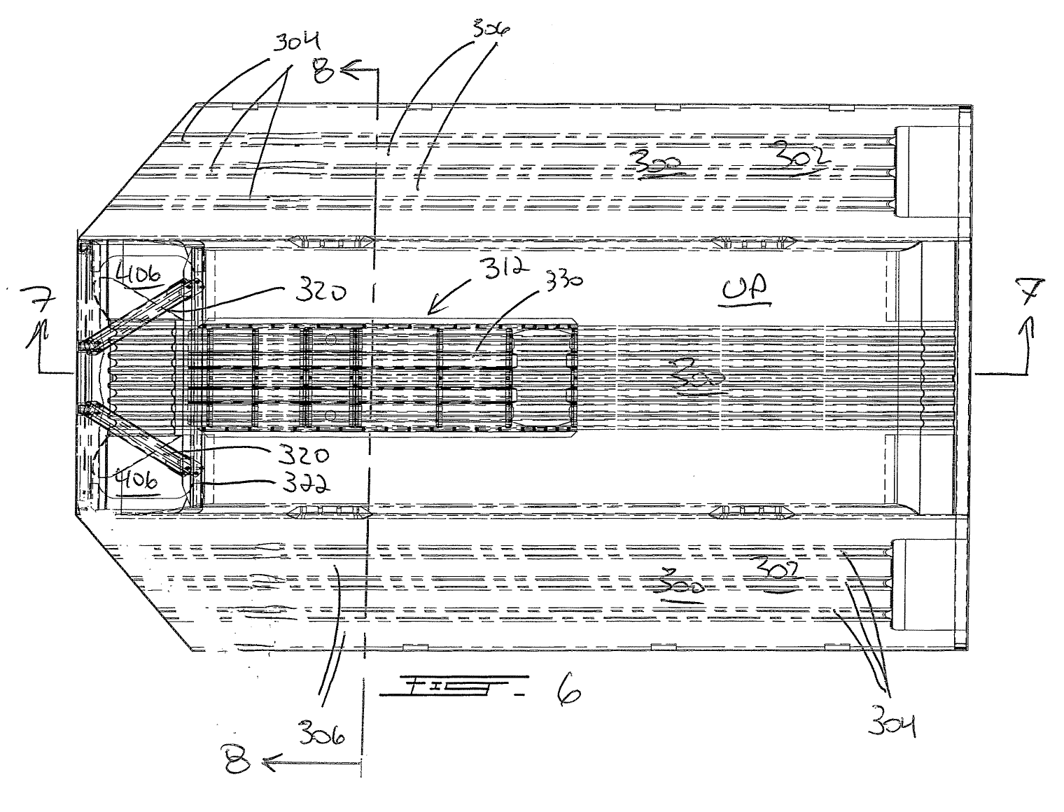

Turning now more specifically to FIGS. 6 through 8 where are illustrated additional frame members 320 adapted to further reinforce the region of the frame 30 adapted to receive the hydraulic motors 406. This is provided, inter alia, because additional stress is created on the front portion of the frame 30 by the hydraulic motors 406 when driving the sprockets 402 and the endless belts 404. Transversal stiffness is provided by transversal member 322.

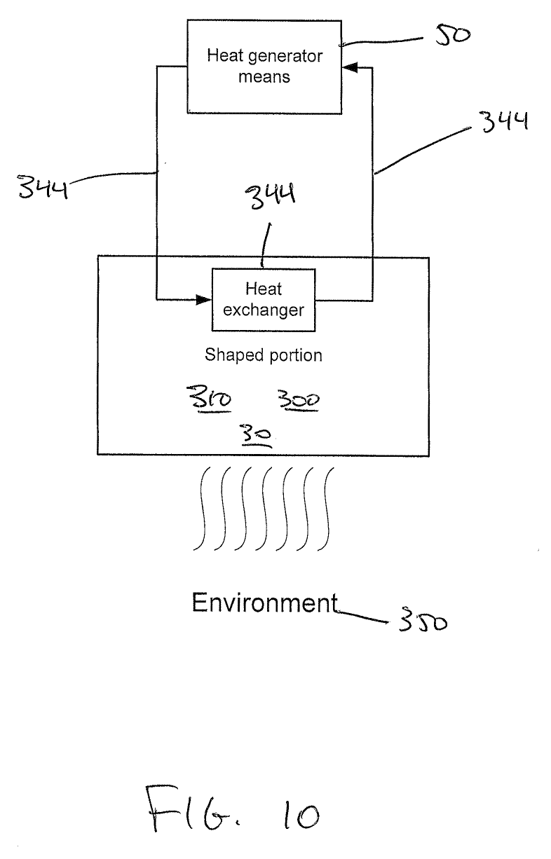

One can appreciate from FIGS. 6 to 9 that a portion of the shaped portion 310 is covered by a frame panel 330 secured in place by fasteners 332. The frame panel 330 further increases the rigidity of the shaped portion 310 by creating a box 312 thereto. The frame panel 330 further comprises wall members 334 transversally interconnecting the frame panel 330 to the shaped portion 310. It can be appreciated that wall members 334 are provided with a mating portion 338 contacting the shaped portion 310. Wall members 334 are adapted to transfer load between the shaped portion 310 and the frame panel 330. A series of openings 336 are defined in the wall members 334 to allow passage of tubes 344 (schematically shown on FIG. 10) therethrough with intervening grommets (not illustrated) to avoid the tubes 344 to wear out by rubbing on the wall member 334 and to prevent any undesirable rattle.

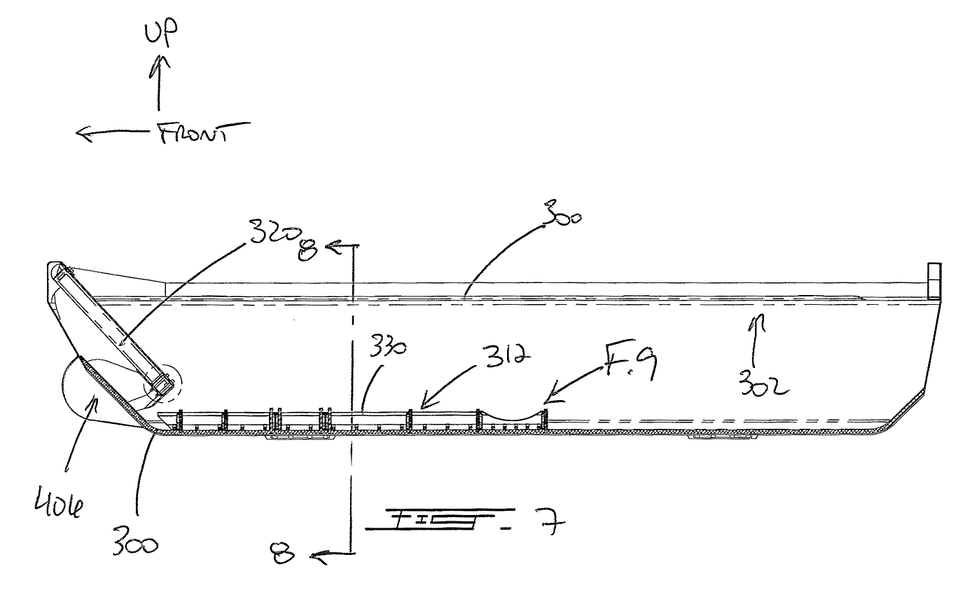

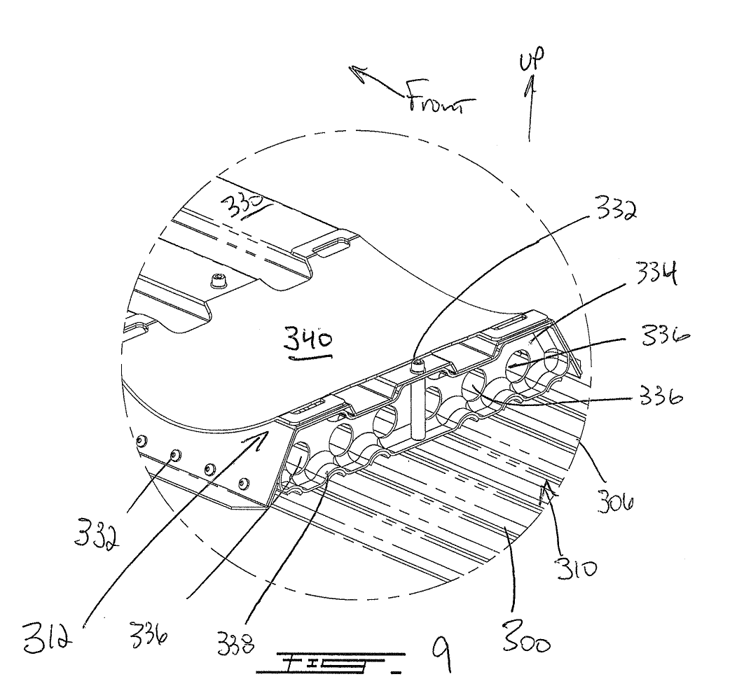

It can further be appreciated from FIGS. 7 and 9 that the frame panel 330 is shaped to receive other elements thereon. For example, a curved shape 340 is ready to mate with an element to be secured to the frame 30.

As mentioned, the series of openings 336 are adapted to receive tubes 344 (not shown on FIGS. 1 through FIG. 9 but schematically illustrated on FIG. 10) channeling [hydraulic] fluid therein. The tubes are preferably made of steel, copper or other material that has significant heat transfer capabilities. The hot fluid is thus cooled by exchanging thermal energy to the frame 30, through the shaped portion 300, 310, between the endless belts 404 that dissipate it to the colder environment. Six openings 336 are illustrated in the present embodiment to allow three loops of tube inside the frame panel 330. A different number of openings 336 is also encompassed by the present invention. Therefore, the shaped reinforcements cooperate with a cooling system of the vehicle to use the frame as a heat exchanger.

The description and the drawings that are presented herein are meant to be illustrative of the present invention. They are not meant to be limiting of the scope of the present invention. Modifications to the embodiments described may be made without departing from the present invention, the scope of which is defined by the following claims:

We claim:

1. A vehicle frame comprising a structural portion of sheet material provided with a series of bents formed therein to increase the stiffness of the structural portion.

2. A vehicle frame comprising a structural portion of sheet material provided with a series of bents formed therein to increase the stiffness of the structural portion, wherein the structural portion is further adapted to be a heat exchanger by communicating thermal energy between a heat carrying means to the environment.

3. A method of exchanging heat from a vehicle to the environment, the method comprising:
providing a structural portion of sheet material having a series of bents formed therein to increase the stiffness of the structural portion;
providing a heat carrying means adapted to channel a heat-charged fluid from a heat generating element of the vehicle to the structural portion of sheet material; and
transmitting heat from the heat carrying means to the environment via the structural portion.
